(19) United States
(12) Patent Application Publication
(10) Pub. No.: US 2014/0222526 A1
(43) Pub. Date: Aug. 7, 2014

(54) SYSTEM AND METHOD FOR AUGMENTING HEALTHCARE-PROVIDER PERFORMANCE

(71) Applicant: Augmedix, Inc., Menlo Park, CA (US)

(72) Inventors: Ian Shakil, San Francisco, CA (US); Pelu Tran, San Francisco, CA (US); Reda Dehy, San Francisco, CA (US)

(73) Assignee: Augmedix, Inc., Menlo Park, CA (US)

(21) Appl. No.: 14/167,353

(22) Filed: Jan. 29, 2014

Related U.S. Application Data
(63) Continuation-in-part of application No. 13/864,890, filed on Apr. 17, 2013.
(60) Provisional application No. 61/762,155, filed on Feb. 7, 2013.

(51) Int. Cl. G06Q 50/22; G06Q 10/06

(52) U.S. Cl. CPC G06Q 50/22; G06Q 10/0639
USPC 705/7.38

(57) ABSTRACT

A system and method for augmenting healthcare-provider performance employs a head-mounted computing device that includes camera and microphones to capture a patient encounter and events immediately before and after: video, dictation and dialog. Wearing the device by the provider during the encounter permits normal interaction between provider and patient, encouraging the provider to maintain focus on the patient. An “ears-open” earpiece delivers audio data from a remote location without obstructing the ear canal. Augmented reality multimedia is displayed via a heads-up display over the eye(s). Real-time capture of audio and video enables dramatic cost reductions by saving doctor time. Using the system, a doctor no longer need spend hours daily on transcription and EHR entry. A patient encounter is captured and transmitted to a remote station. Relevant parts of the encounter are saved or streamed, and updates to an EHR are entered for provider confirmation after the patient encounter.

### CROSS-REFERENCE TO RELATED APPLICATIONS

This application is a continuation-in-part of prior application Ser. No. 13/864,890 filed 17 Apr. 2013, which claims the benefit of U.S. Provisional Application Ser. No. 61/762,155 filed 7 Feb. 2013, which are both incorporated in their entirety herein by this reference.

### TECHNICAL FIELD

This invention relates generally to the optical user interface field, and more specifically to a new and useful system and method for augmenting healthcare-provider performance.

### BACKGROUND

Healthcare currently represents eighteen percent of the gross domestic product of the United States and continues to expand rapidly. The healthcare enterprise in the U.S. and many other nations of the developed world is viewed generally as being massively inefficient and, thus, ripe for disruption. As the healthcare sector continues to grow, thanks to innovations in medical treatment and longer life expectancies, demands on doctors keep increasing. Unfortunately, doctor time is a scarce resource. There are fewer physicians per person in the U.S. than in any of the other 34 OECD (Organization for Economic Cooperation and Development) countries, straining doctors to keep up with the demand for their professional opinions and time. Notably, there is a current shortage in the U.S. of 9,000 primary care doctors, with the gap predicted to worsen to 65,000 physicians within 15 years. As a result of these demands upon doctors, which are further exacerbated by record-keeping demands, doctors spend much of their time recording information. With the passage of the Affordable Care Act in 2010, medical records need to be compliant with a “Meaningful Use” clause of the law, which has significantly added to the amount of time providers must spend inputting healthcare data. Such increases in the amount of time providers spend inputting data have contributed to an erosion of doctor-patient relationships and regressions in provider bedside manner.

There are also important economic consequences of the requirement to capture such massive amounts of data. Providers find that they are able to see fewer patients every day as a result of the requirements posed by electronic health records, further straining the already-limited resource of provider time. The financial climate for the medical profession is rapidly deteriorating: revenues are under pressure as a result of declining reimbursement rates; expenses are rising due to the myriad costs involved in providing services; and malpractice insurance rates just become more onerous. Providers therefore feel a desperate need to explore every possible avenue to bring their fiscal situation into order.

Thus, there is a need to create a new and useful system and method for augmenting healthcare-provider performance. This invention provides such a new and useful system and method.

### BRIEF DESCRIPTION OF THE FIGURES

FIG. 1 provides a diagram of an embodiment of a system for augmenting healthcare-provider performance;

FIG. 2 provides a diagram of an additional embodiment of a system for augmenting healthcare-provider performance;

FIG. 3 provides a diagram of an additional embodiment of a system for augmenting healthcare-provider performance;

FIG. 4 provides a block diagram of a computational infrastructure underlying an embodiment of a system for augmenting healthcare-provider performance;

FIGS. 5-7 provide assorted example views of a mobile provider interface from an embodiment of a system for augmenting healthcare-provider performance;

FIG. 8 provides a diagram of a portion of an embodiment of a system for augmenting healthcare-provider performance;

FIGS. 9-11 provide exemplary screen shots from a user interface in examples of the mobile provider interface of FIGS. 5-7; and

FIG. 12 depicts an embodiment of a method for augmenting healthcare-provider performance.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System

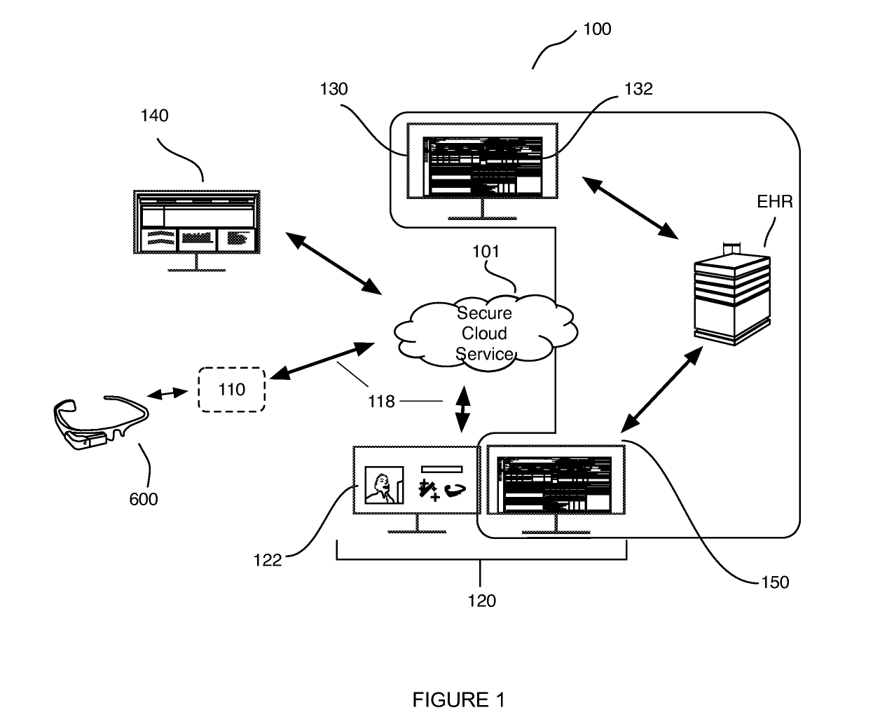

As shown in FIG. 1, an embodiment of a system 100 for augmenting performance of a provider includes: a mobile provider interface 110 coupled to a display 112 worn by the provider, wherein the display communicates information to the provider during a set of interactions with a patient; a scribe cockpit 120 including a scribe cockpit interface 122 configured to transmit a dataset, derived from the set of interactions and generated by the mobile provider interface, to a scribe and transmit a communication between the scribe and the provider; a provider workstation 130 configured to facilitate review of the communication by the provider; and a scribe manager module 140 configured to administrate a set of scribe tools to the scribe and manage a set of scribe-provider interactions. In some variations, the system 100 can further include an electronic health record (EHR) interface 150 coupled to at least the scribe cockpit 120 and the provider workstation 130, which functions to provide information regarding health records of at least one patient of the provider. Preferably, the mobile provider interface 110, the scribe cockpit 120, the provider workstation 130, and the scribe manager module 140 are configured to communicatively couple to each other, and can couple by a secure cloud-based service 100; however, in alternative variations, any one or more of the mobile provider interface 110, the scribe cockpit 120, the provider workstation 130, and the scribe manager module 140 can be coupled in any other suitable manner.

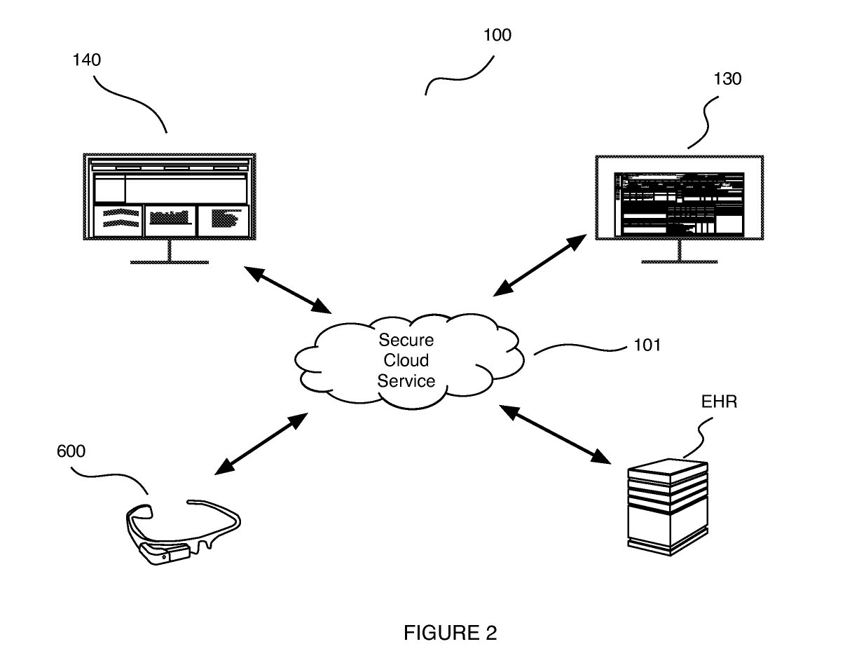

The system 100 functions to significantly decrease or eliminate an amount of time over which a provider must enter information into a database, thus increasing the time the provider has to spend with a given patient, and increasing the quality of provider-patient interactions. As such, the system 100 can free the provider from a set of mundane tasks, which can be instead performed by a human and/or an automaton (e.g., virtual) scribe. Furthermore, in variations of the system 100 including only an automaton scribe, the system 100 can entirely omit the scribe cockpit 120, as shown in FIG. 2. Preferably, the scribe is remote (e.g., not in the immediate vicinity of the patient encounter) from the provider as the provider interacts with a patient; however, in some variations, the provider can alternatively be located in proximity to the scribe. In various embodiments, the scribe may be physically located in the same healthcare facility in which the patient encounter is taking place, or the Scribe may be located, for example, in a facility that is on the other side of the world from the location of the patient encounter and any point therebetween. The system 100 is preferably implemented in a clinical setting, such that the provider is a healthcare provider (e.g., medical doctor, nurse, nurse practitioner, physician's assistant, paramedic, combat medic, physical therapist, occupational therapist, dentist, pharmacist, etc.) interacting with a patient; however, in other variations, the system 100 can be implemented in a research or another suitable setting.

Preferably, stringent security provisions are incorporated into the system 100 and/or implemented by the system 100, according to federal regulations and/or any other suitable regulations. Example security provisions can include any one or more of: regular checks that regulatory and legislative compliance requirements are met; security awareness training provided to all staff; account lock-out (e.g., if a user incorrectly authenticates a given number of times, their user account will be locked); encryption over-the-wire (“in-transit”) as well as in backend systems (“at-rest”); full audit trail documentation (e.g., audit trail of the past 12 months, complete audit trail); and hosting of servers in highly secure environments with administrative access given to not more than 2 senior employees. Security checks can include: 24/7 physical security; on-going vulnerability checks; daily testing by anti-malware software such as MCAFEE SECURED for known vulnerabilities; and adopted best practices such as Defense in Depth, Least-Privilege and Role Based Access Control. However, the system 100 can implement any other suitable security measures.

### 1.1 System—Mobile Provider Interface

The mobile provider interface 110 functions to enable transmission of information to the provider, and enable transmission of data derived from a set of interactions between the provider and a patient to a scribe. The mobile provider interface can also function to enable the provider to generate a request, as described in Section 2 below. The set of interactions can include any one or more of: conversations between the provider and the patient, wherein the patient provides symptoms, progress, concerns, medication information, allergy information, insurance information, and/or any other suitable health-related information to the provider; transactions wherein the patient provides demographic and/or family history information to the provider; interactions wherein the provider facilitates performance or acquisition of lab tests for the patient; interactions wherein the provider generates image data (e.g., from x-rays, MRIs, CT scanning, ultrasound scanning, etc) from the patient; interactions wherein the provider generates other health metric data (e.g., cardiology-related data, respiratory data) from the patient; and/or any other suitable interaction between the provider and the patient.

The mobile provider interface 110 thus preferably facilitates presentation of information to the provider as the provider interacts with the patient during the patient encounter. Typically, the patient encounter is an interactive session wherein the provider is examining the patient in a clinical setting or in the examining room of an office or other healthcare facility and eliciting information from the patient by questioning the patient. The environment of use, however, is not meant to be limiting and may also include an encounter in a hospital emergency room, or in an operating suite wherein the patient is present but unconscious. Additionally or alternatively, the encounter may occur, for example, at the scene of an accident, at the scene of a mass casualty or even under battlefield conditions. Additionally or alternatively, the encounter can take place in any other suitable environment (e.g., the patient's home, a research setting, etc.).

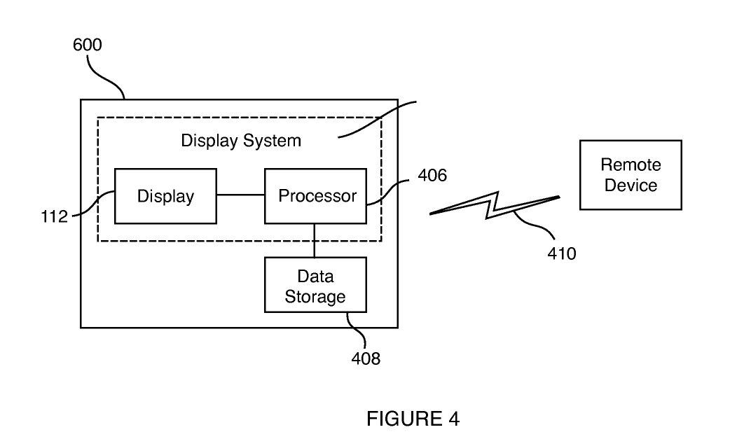

The mobile provider interface 110 can couple to a computing device 600 including a display 112 and a processor 406 configured to render information to the provider, as shown in FIG. 4, and a speaker configured to provide information in an auditory manner. In variations of the computing device 600 including a display 112, the display 112 can be an optical see-through display, an optical see-around display, or a video see-through display. Furthermore, the processor 406 can be configured to receive data from any suitable remote device or module (e.g., a scribe cockpit 120, a scribe manager module 140, an EHR interface 150, etc.), and configure the data for display on the display 112 of the computing device 600. The processor 406 can be any suitable type of processor, such as a micro-processor or a digital signal processor, for example. Furthermore, the processor 406 can be coupled to a data storage unit 408 (e.g., on-board the computing device 600, off-board the computing device 600, implemented in cloud storage, etc.), wherein the data storage unit 408 can be configured to store software that can be accessed and executed by the processor 406. In some variations, the computing device 600 can further include an environment sensing module 114 including one or more of an optical sensor (e.g., integrated into a camera, integrated into a video camera), an audio sensor, and an accelerometer. However, in some variations, the computing device 600 can omit at least one of the display 112 and the speaker, and/or can include any other suitable sensors in the environment sensing module 114.

The computing device 600 preferably enables transmission of data generated using the computing device 600 by way of a communication link 410 (e.g., a wired connection, a wireless connection) that can be configured to communicate with a remote device. For example, the communication link 410 can be a wired serial bus such as a universal serial bus or a parallel bus, or any other suitable wired connection (e.g., proprietary wired connection). The communication link 410 can also be a wireless connection using, for example, BLUETOOTH radio technology, communication protocols described in IEEE 802.11 (including any IEEE 802.11 revisions), Cellular technology (such as GSM (Global System for Mobile Communications), CDMA (Code Division Multiple Access), UMTS (Universal Mobile Communications System), EVDO (EVolution Data Optimized), WiMAX (Worldwide Interoperability for Microwave Access), or LTE (Long-Term Evolution)), NFC (Near Field Communication), ZIGBEE (IEEE 802.15.4) technology, and any other suitable wireless connection. The remote device may be accessible via the Internet and may include a computing cluster associated with a particular web service (e.g., social-networking, photo sharing, address book, etc.). In variations, the remote device configured to communicate with the computing device 600 by the communication link 410 can include any suitable device or transmitter including a laptop computer, a mobile telephone, tablet computing device, or server, etc., that is configured to transmit data to the computing device 600. The remote device and the computing device can further cooperate and contain hardware to enable the communication link 410, such as processors, transmitters, receivers, antennas, etc. Additionally, the remote device may constitute a plurality of servers over which one or more components of the system 100 may be implemented.

The computing device 600 preferably allows the provider to use both of his/her hands freely, and preferably allows the provider to remain substantially mobile during his/her day-to-day operations. Preferably, the computing device 600 is configured to be worn by the provider (e.g., in a similar manner to eyeglasses, in a similar manner to a headset, in a similar manner to a headpiece, in a similar manner to earphones, etc.); however, the computing device 600 can additionally or alternatively be configured in an environment of the provider (e.g., configured in a room surrounding the provider) in order to provide information to the provider and to transmit data derived from actions of the provider. In some variations, however, the computing device 600 can alternatively occupy one or both hands of the provider, can limit the provider's mobility, and/or can be configured in any other suitable manner.

In variations, the computing device 600 can additionally or alternatively include sensors and elements for any one or more of: multi-channel video, 3D video, eye-tracking, gestural detection (e.g., wink detection), coupling detection (e.g., “on-head” detection), air temperature, body temperature, air pressure, skin hydration, electrodermal activity, exposure to radiation, heart rate, respiration rate, blood pressure, and any other suitable sensor configured to detect biometric or environmental signals. As such, the computing device 600 can facilitate acquisition of biometric data from the provider, and/or contextual data from the provider's environment. Some variations of the computing device 600 can additionally or alternatively include one or more accelerometers (e.g., for redundancy), gyroscopes, compasses, and/or system clocks to facilitate orientation, location, and/or time-based measurements. Variations of the computing device 600 can also include circuitry for one or both of wireless communication and geo-location. In variations wherein the computing device 600 is configured to provide information in an auditory manner, the computing device 600 can include or be coupled to an earpiece (e.g., open-canal earpiece, in-ear earpiece, etc.) for delivery of remotely-transmitted audio data to the provider and/or any other member. In some variations, the computing device 600 can further capture ambient sound in the immediate vicinity of the patient encounter. Ambient sound may include conversation between the provider and a patient or among various members of a healthcare team that may be present during the patient encounter. In addition to retrieving information, the provider, via the mobile provider interface 110, is able to transmit data generated and captured during the patient encounter for documentation purposes as described further below. As such, data generated and captured during the patient encounter can be manually and/or automatically generated/transmitted.

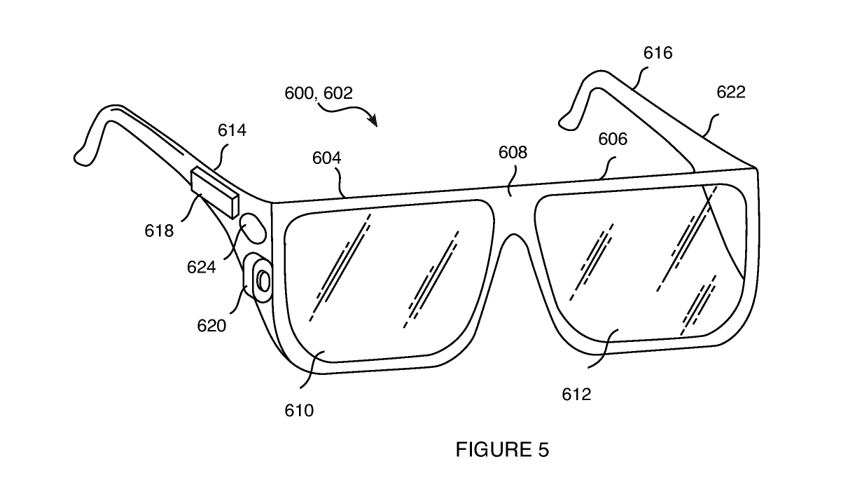

In specific examples, as shown in FIGS. 5-7, the computing device 600 can be a wearable head-mounted computing device 602. In various examples, the computing device 600 can be the VUZIX M100 video eyewear device, Google Glass, Looxcie wearable camera device, a virtual reality headset (e.g., Oculus Rift), and/or any other similar head-mounted display device or wearable augmented reality device. In describing a specific example in further detail, the computing device 6000 can include a plurality of frame elements including one or more of: a set of lens-frames 604, 606, a center frame support 608, a set of lens elements 610, 612, and a set of extending side arms 614, 616. As shown in FIG. 5, the center frame support 608 and the extending side-arms 614, 616 can be configured to secure the head-mounted device 602 to a user's face (e.g., the provider's face) at the user's nose and ears. Each of the frame elements 604, 606, and 608 and the extending side-arms 614, 616 can constitute either a solid structure of plastic and/or metal, or a hollow structure of similar material so as to allow wiring and component interconnects to be internally routed through the head-mounted device 602. Additionally, any of the lens elements 610, 612 can be formed of any material (e.g., polycarbonate, CR-39, TRIVEX) that can suitably display a projected image or graphic. Each lens element 610, 612 can also be sufficiently transparent to allow a user to see through the lens element. Thus, combining displaying capabilities and transparency can facilitate an augmented reality or heads-up display wherein a projected image or graphic is superimposed over a real-world view as perceived by the user through the lens elements 610, 612. Furthermore, one or both of the extending side-arms 614, 616 can be projections that extend away from the lens-frames 604, 606, respectively, and can be positioned behind a user's ears to secure the head-mounted device 602 to the user. The extending side-arms 614, 616 can further secure the head-mounted device 602 to the user by extending around a rear portion of the user's head. In variations of the example, one or both of the extending side arms 614, 616 can include an earpiece (e.g., open ear earpiece, bone-conduction earpiece, etc.). A bone-conduction earpiece minimizes the possibility that data transmitted to the provider will be overheard by others. Additionally, a bone-conduction earpiece keeps the provider's ear canal open.

In the specific example, the computing device 600 also includes an on-board computing system 618, a video camera 620, a sensor 622, and a finger-operable touch pad 624. As shown in FIG. 5, the on-board computing system 618 is configured to be positioned on the extending side-arm 614 of the head-mounted device 602. In variations of the specific example, the on-board computing system 618 can be provided on other parts of the head-mounted device 602 and/or can be positioned remote from the head-mounted device 602 (e.g., wired or wirelessly-connected to the head-mounted device 602). The on-board computing system 618 in the specific example includes a processor and memory, and is configured to receive and analyze data from the video camera 620 and the finger-operable touch pad 624 and generate images for output by the lens elements 610 and 612. In the specific example, the video camera 620 is shown positioned on the extending side-arm 614 of the head-mounted device 602. In other variations of the specific example, the video camera 620 can be provided on other parts of the head-mounted device 602. The video camera 620 can further be configured to capture images at various resolutions or at different frame rates. Furthermore, video cameras having a small form-factor (e.g., mobile device video cameras) can be incorporated into additional variations of the computing device 600. Further, although FIG. 5 illustrates a single video camera 620, additional video cameras can be used in variations of the specific example. Each video camera 620 of a set of video cameras can be configured to capture the same field of view, or to capture different fields of view. For example, the video camera 620 may be forward facing to capture at least a portion of the real-world view perceived by the user. This forward-facing image captured by the video camera 620 may then be used to generate an augmented reality where computer generated images appear to interact with the real-world view perceived by the user.

Although the sensor 622 is shown on the extending side-arm 616 of the head-mounted device 602 in the specific example of FIG. 5, in variations of the specific example, however, the sensor 622 can be positioned at any other suitable location of the head-mounted device 602. The sensor 622 in the specific example includes one or more of a gyroscope, an accelerometer, and a compass. Other sensing devices can be included within, or in addition to, the sensor 622 or other sensing functions may be performed by the sensor 622 in variations of the specific example. The finger-operable touch pad 624 is used by a user to input commands. In the specific example, the finger-operable touch pad 624 is shown on the extending side-arm 614 of the head-mounted device 602 in FIG. 5. However, the finger-operable touch pad 624 can be positioned on other parts of the head-mounted device 602 in variations of the specific example. Additionally, multiple finger-operable touch pads can be present on the head-mounted device 602 in variations of the specific example. The finger-operable touch pad 624 senses at least one of a position and a movement of a finger by capacitive sensing, resistance sensing, or a surface acoustic wave process, but can sense position and/or movement in any other suitable manner in variations of the specific example. In the specific example, the finger-operable touch pad 624 is capable of sensing finger movement in a direction parallel or planar to the pad surface, but can be additionally or alternatively be capable of sensing movement in a direction normal to the pad surface and/or be capable of sensing a level of pressure applied to the pad surface in variations of the specific example. In the specific example, the finger-operable touch pad 624 is formed of one or more translucent or transparent insulating layers and one or more translucent or transparent conducting layers. In variations of the specific example, edges of the finger-operable touch pad 624 can be formed to have a raised, indented, or roughened surface, so as to provide tactile feedback to a user when the user's finger reaches the edge, or other area, of the finger-operable touch pad 624. In variations of the specific example including more than one finger-operable touch pad is present, each finger-operable touch pad may be operated independently, and may provide a different function.

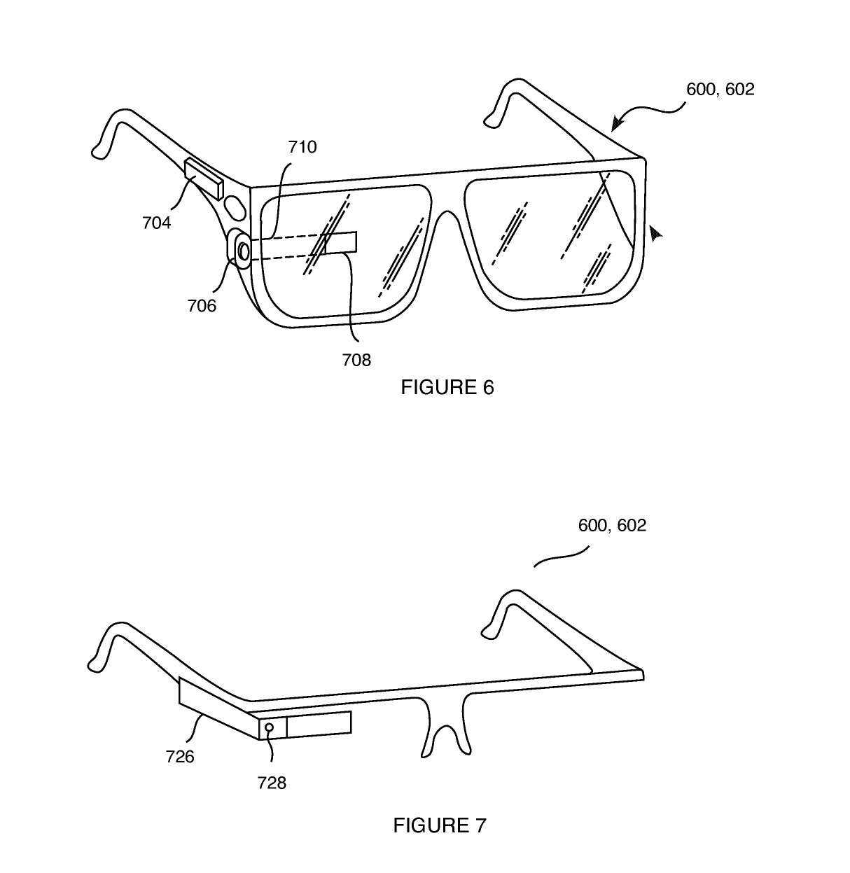

In one variation of the specific example, as shown in FIG. 6, the head-mounted device 602 includes frame elements and side-arms such as those described with respect to the specific example shown in FIG. 5. The head-mounted device 602, as shown in FIG. 6, includes an on-board computing system 704 and a video camera 706, such as those described with respect to FIG. 5. The video camera 706 is shown mounted on a frame of the head-mounted device 602; however, in other variations of the specific example, the video camera 706 can be mounted at other positions as well. In this variation of the specific example, the head-mounted device 602 includes a single display 708 which coupled to the device. The display 708 is formed on one of the lens elements of the head-mounted device 602, such as a lens element described with respect to FIG. 6, and is configured to overlay computer-generated graphics in the user's view of the physical world. The display 708 is shown to be provided in a center of a lens of the head-mounted device 602; however, the display 708 may be provided in other positions in other variations of the specific example. The display 708 is controllable via the computing system 704 that is coupled to the display 708 via an optical waveguide 710.

In another specific example, as shown in FIG. 7, the head-mounted device 602 does not include lens-frames containing lens elements. The head-mounted device 602 may additionally include an onboard computing system 726 and a video camera 728, such as those described with respect FIGS. 5 and 6. In other variations and examples, the computing device 600 can be coupled to the provider in any other suitable manner, and/or can be configured to follow motions of the provider in any other suitable manner. For example, the computing device 600 can be a device that includes a transportation mechanism (e.g., wheels, track, hovering mechanism, propulsion mechanism, etc) that follows the provider as the provider moves during an interaction with a patient. Furthermore, although the foregoing description assumes that a single provider is wearing the computing device 600, in additional embodiments, other members of the healthcare team and/or any other suitable member may be present during the patient encounter and one or more of the members/providers can be equipped with a wearable computing device 600 configured to couple with the mobile provider interface 110. Even further, while FIGS. 5-7 illustrates a head-mounted device as examples of a wearable computing device, other types of wearable computing devices could additionally or alternatively be used, such as Augmented Reality Contact Lenses (INNOVEGA, INC., Bellevue, Wash.), or any other suitable non-head-mounted device. Additionally, gestural augmented reality interfaces such as SIXTHSENSE (MIT MEDIA LAB, Massachusetts Institute of Technology, Cambridge, Mass.) or various wearable aural augmented reality interfaces may form part or all of the computing device 600 interfaces in variations of the system 100.

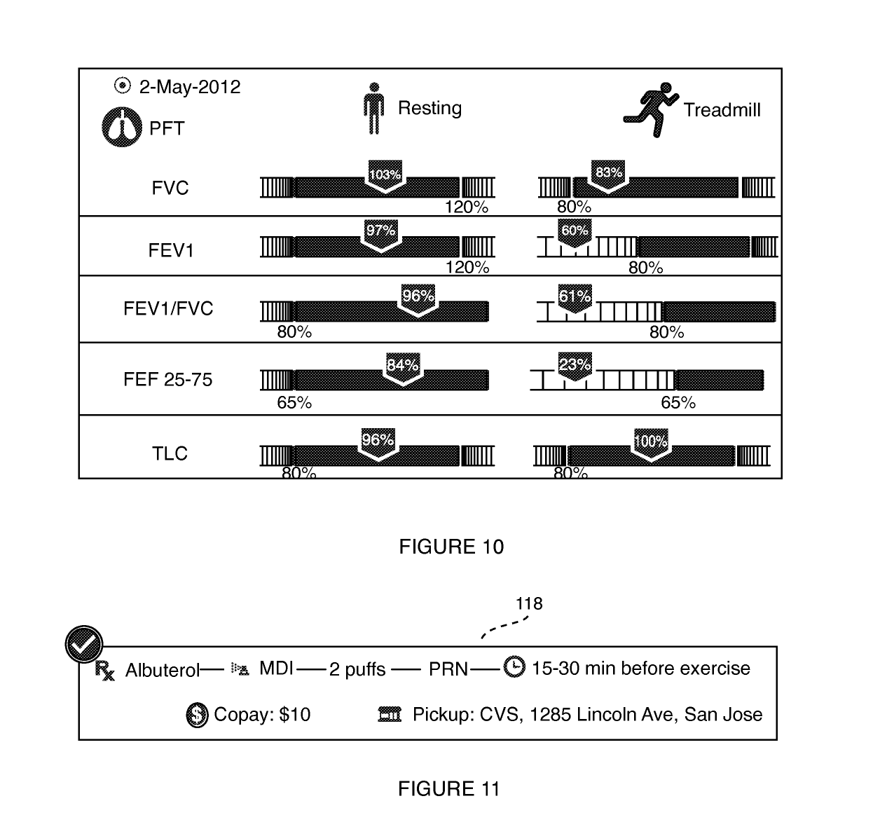

The provider and/or the computing device 600, in execution with the mobile provider interface 110, preferably communicate with other elements of the system 100 by way of a concierge software module 118, as shown in FIG. 1, which functions to allow a provider to summon information from one or more sources, and to receive a response (e.g., at the computing device). The sources can be electronic databases, scheduling systems and tools, electronic information sources (e.g., Wikipedia, PUBMED, UPTODATE, EPOCRATES), and electronic health records, can be mediated by a scribe operating at a scribe cockpit 120 as described below, and/or can be procured in any other suitable manner. In specific examples, the concierge software module 118 can allow a provider to summon specific information (e.g., white blood cell count, CXR results, pulmonary function test results, etc.) pertaining to the patient, as shown in FIG. 10, and to receive a response (e.g., test results, cell counts, images, etc.) that satisfies the provider's request. In variations, the response can be provided and/or rendered at a display of a computing device 600 accessible by the provider during interactions with the patient, and/or during review of content generated by the scribe.

In some variations, the concierge software module 118 can perform additional functions for the provider including one or more of: facilitating placement of prescription orders, dictating orders, and confirming requests, as shown in FIG. 11, facilitating patient recognition and/or geolocation based upon GPS sensors and interfacing with the EHR of the patient (e.g., upon coming into proximity of the patient, the concierge software module can facilitate rendering of the name, picture, medical record number, chief complaint, and medically relevant data of the patient at a display of the computing device 600 worn by the patient), placing the computing device in “incognito mode” (e.g., to stop recordation of the provider-patient interaction(s) for legal, privacy, or personal reasons), enabling the provider to request recordation of portions of the provider-patient interaction(s) (e.g., for transmission to the patient and/or a caretaker of the patient), and any other suitable functions as described in Section 2 below.

### 1.2 System—Scribe Cockpit

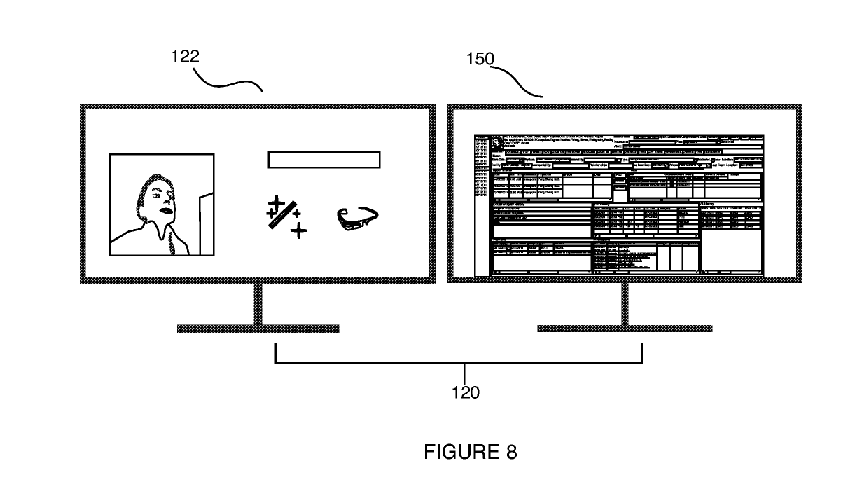

As shown in FIGS. 1 and 8, the scribe cockpit 120 functions to transmit information from a set of interactions between the provider and a patient to a scribe. As such, the scribe cockpit 120 enables a scribe to receive information from interactions between a patient and the provider, which can be used to provide guidance and/or feedback to the provider. The scribe cockpit 120 can also facilitate transmission of a communication, related to the set of interactions, between the scribe and the provider. The scribe cockpit 120 preferably includes a scribe cockpit interface 122 configured to transmit a dataset, derived from the set of interactions and generated by the mobile provider interface, to a scribe and transmit a communication between the scribe and the provider. In some variations, the scribe cockpit 120 can additionally or alternatively be configured to couple to an EHR interface 150, such as the EHR interface 150 described below; however, the scribe cockpit 120 can additionally or alternatively be configured to couple to any other suitable interface in any other suitable manner. Furthermore, in recognition of the highly confidential nature of healthcare data, a variation of the scribe cockpit 120 can include an authentication protocol (e.g., a multi-level authentication protocol) that requests secure authentication by the scribe on the scribe cockpit interface 122 and/or on the EHR interface 150. However, in other variations, the scribe cockpit 120 can entirely omit an authentication protocol and/or provide security in any other suitable manner.

The scribe cockpit interface 122 functions to relay information from an interaction between the provider and a patient to the scribe, such that the scribe can enter relevant data extracted from the interaction and/or provide a communication pertaining to the interaction to the provider. As such, the scribe cockpit interface 122 preferably couples to a display and a speaker, in order to transmit video and audio streams from provider-patient interactions; however, in some variations, the scribe cockpit interface 122 can couple to one of a display and a speaker in order to transmit video or audio streams to the scribe. In some variations, the scribe cockpit 120 and/or the scribe cockpit interface 122 can incorporate a set of displays, can incorporate a virtual reality module (e.g., a virtual reality display, gestural control), and/or can incorporate any other suitable module that facilitate presentation of information to the scribe/generation of content by the scribe. In variations wherein the scribe cockpit interface 122 facilitates video streaming the scribe cockpit interface 122 can also facilitate one or more of archive access (e.g., as in archives of past interactions with one or more patients and/or one or more providers), fast forward of video, rewind of video, high-speed playback, slow-speed playback, and any other suitable video manipulation function. Similarly, in variations wherein the scribe cockpit interface 122 facilitates audio streaming, the scribe cockpit interface 122 can also facilitate one or more of: archive access, fast forward of audio, rewind of audio, high-speed playback, slow-speed playback, and any other suitable audio manipulation function.

The scribe cockpit interface 122 preferably also couples to a scribe input module that allows a scribe to input data and/or any other suitable information derived from the set of interactions between the provider and the patient. Preferably, the scribe input module includes a touch input device (e.g., a keyboard, a keypad, a mouse, a track pad, a touch screen, a pointing stick, foot pedal, gesture detection module, etc.), and can additionally or alternatively include an audio input device (e.g., a microphone, a microphone system configured to distinguish audio information sources) and/or a visual input device (e.g., a camera, a set of cameras). As such, the scribe input module provides a tool that enables the scribe to document important aspects of the set of interactions between the provider and the patient. Information that can be documented using the scribe input module can include patient symptoms, progress, concerns, medication information, allergy information, insurance information, and/or any other suitable health-related information; patient demographic and/or family history information; lab test results; image data (e.g., from x-rays, MRIs, CT scanning, ultrasound scanning, etc) from the patient; other health metric data (e.g., cardiology-related data, respiratory data) from the patient; and/or any other suitable information. In variations of the system 100 including an EHR interface 150, the scribe input module can enable the scribe to access and/or manipulate electronic health records for one or more patients of the provider.

The scribe cockpit interface 122 preferably also includes a message client that functions to enable communication between the scribe and the provider, as facilitated by the scribe cockpit interface 122. The message client preferably communicates with a server of a message service provider, a server of a mailbox service that is a proxy for the message service provider, and/or any suitable messaging service. The message client preferably enables sending and receiving of messages/communications/cards, facilitates timing of content sent and/or received, and can incorporate messages into a rendered interface. Preferably, either the provider or the scribe can initiate a communication by using the message client; however, alternatively, only the provider may initiate a communication using the message client. The message client preferably also enables communication between more than two entities (e.g. a provider may communicate with multiple scribes, a scribe may communicate with multiple providers); however, in some variations, the message client can limit communications to parties of only two entities (e.g., the scribe and the provider).

In one variation, the message client of the scribe cockpit interface 122 can allow the provider to transmit a query to the scribe, to which the scribe can transmit a response that resolves the query. In examples, the scribe can input an answer (e.g., by typing, by speaking, by providing a link to an answer, etc.) at the message client for transmission back to the provider; the scribe can use one of multiple tools, which are described in more detail below, including a tool to select graphics, tables, and manipulated screen shots from a database (e.g., accessible by the EHR interface 150 described below) that can be transmitted back to the provider; the scribe can provide assistance in diagnosing one or more conditions of the patient(s); the scribe can provide assistance in prescribing treatments or medications to the patient(s); and the scribe can transmit textual and/or graphical data from sources (e.g., journal articles, clinical studies, treatment guidelines, equipment manuals, device manuals, procedure checklists, drug information) and/or any other relevant medical or technical data to the provider. The message client can, however, facilitate any other suitable communication between the scribe(s) and the provider(s).

In one embodiment of the system 100, the scribe cockpit 120 can be implemented in part using a scribe software module 128. In one variation, the scribe software module 128 can facilitate transmission of an audio-visual stream (e.g., a real-time stream, a non-real time stream, a complete stream, a partial stream, etc.), from the doctor's perspective using the mobile provider interface 110, to the scribe and/or any other suitable entity at a remote location. As above, the scribe can be a human scribe or an automaton scribe composed of one or more software elements, components, or modules executing on a computing device. Furthermore, any suitable additional entity/entities can benefit from the scribe software module 128, such as a consultant invited to participate in a provider-patient interaction to provide a second opinion to the patient and/or the provider, an instructor invited to instruct the provider (e.g., a trainee) needing supervision or guidance in assessing patient condition(s)/treating the patient, a student who is authorized to witness the provider-patient interaction as part of an instruction experience, a caretaker (e.g., family member, guardian, legal representative, etc.) of the patient authorized to witness the provider-patient interaction in order to assess the patient's competence, a consulting healthcare professional also providing care to the patient, and any other suitable entity.

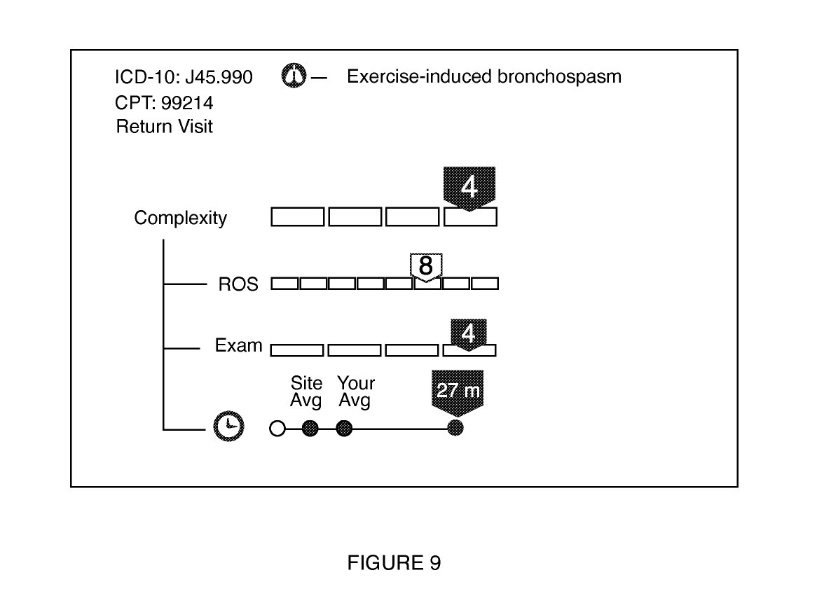

The scribe software module 128 preferably allows the scribe to complete taking notes and documentating aspects of the provider-patient interaction, in real time and/or in non-real time, on behalf of the provider. Furthermore, the scribe software module 128 enables the scribe to manage routine EHR elements (e.g., dropdown menus, forms, templates, etc.) so that the provider's entire focus can remain with the patient, and to increase the provider's time to perform other desired activities. At the end of the day, or at the end of the interview, when the provider turns his/her attention to the provider workstation 130 and/or head-mounted computing device, all he or she needs do is review content generated by the scribe, and confirm the content. In an embodiment, the scribe software module 128 can include one or both of NLP (natural language processing) and speech recognition software that processes a spoken portion of the transmission from a provider-patient interaction to textual data for entry, in whole, or in part, into health records (e.g., at an EHR interface) of the patient and/or for eventual archiving. NLP and speech recognition can further augment the performance of the scribe in any other suitable manner (e.g., by providing subtitles to the scribe as the scribe is reviewing information generated at the mobile provider interface, etc.). As such, NLP algorithms can be used to automatically incorporate speech information derived from the set of interactions into a health record of the patient. For example, NLP can be used to detect medication information from spoken interactions between the provider and the patient, and to update a health record of the patient with medications that the patient is or is not taking. In a specific example of an interaction and an interface 900 enabled by the scribe software module 128, as shown in FIG. 9, a patient communicates a complaint of shortness of breath, which a scribe documents and, using the scribe software module 128, subsequently transmits a communication back to the provider. The documentation and communication supplies the correct diagnosis, diagnostic codes and procedure codes to the provider (e.g., in real time, in non-real time). Furthermore, in the example, as shown in FIG. 9, the documentation and communication provides a summary of the findings: complexity, ROS (review of systems) and the extent of the physical exam with the patient. Additionally, the documentation and communication displays the amount of time spent with the patient and compares the time spent with the average for the provider and for the facility. However, in other variations, the scribe software module 128 can include any other suitable functionalities and/or be implemented in any other suitable manner.

### 1.3 System—Provider Workstation

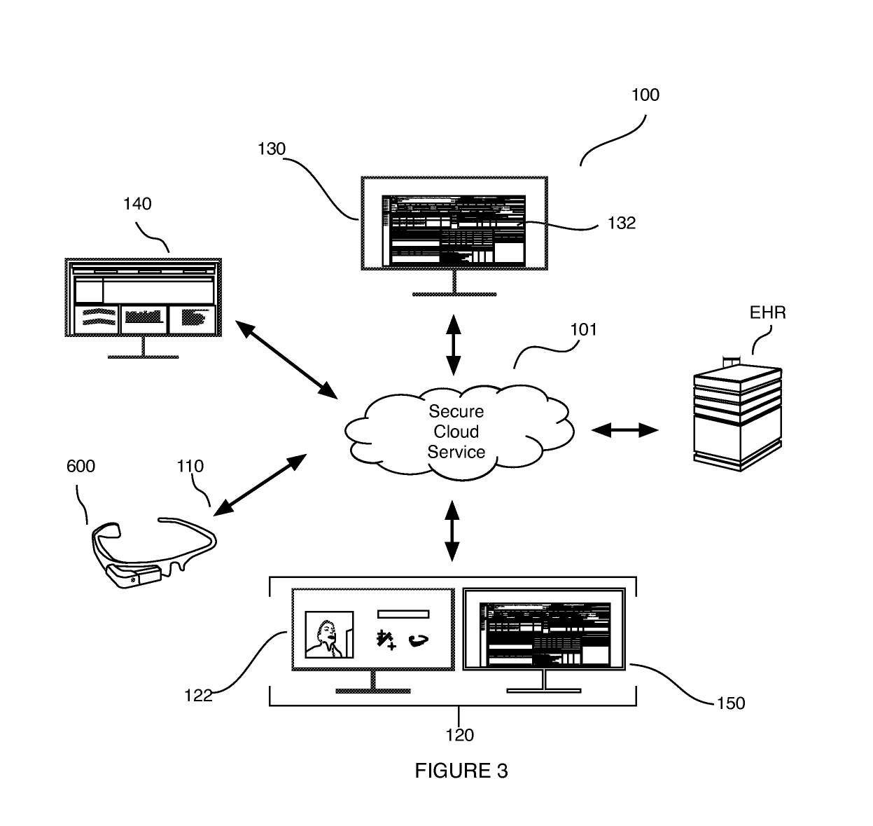

The provider workstation 130 functions to facilitate transmission of the communication between the scribe and the provider, thus enabling the communication and/or any data entry performed by the scribe to be reviewed by the provider (e.g., for accuracy). The provider workstation 130 preferably includes or is coupled to a user interface 132 that allows the provider to review the communication and/or the content generated by the scribe, and can further allow the provider to manipulate content generated by the scribe. The coupling of the provider workstation 130 with the remainder of the system can be implemented using a wired and/or a wireless connection. In one variation, the user interface 132 is created and implemented by a vendor or a manufacturer of an EHR management software application and provides the capability for non-medical or medical personnel to write documentation from the communication and/or data generated and captured during and as a result of a patient encounter. The EHR management software application can provide a ‘pending’ feature, wherein the documentation created by the scribe does not become a permanent part of the patient's EHR unless and until the pending content is reviewed by the provider and confirmed. Additionally or alternatively, the EHR management software application can implement version control with history documentation, such that iterations of data entry can be saved, accessed, and analyzed (e.g., for accuracy, for conflicting information, for training purposes, etc.). Additionally, the user interface 132 can allow the provider to edit content generated by the Scribe. In another variation, as shown in FIG. 3, the user interface 132 can be autonomous from the EHR and/or EHR interface 150, while synchronizing with the EHR data via one or more APIs (application programming interfaces) and one or more standards such as HL7 (HEALTH LEVEL 7 INTERNATIONAL) that define the format for transmission of health-related information.

Similar to the scribe cockpit 120, the provider workstation 130 can implement an authentication protocol (e.g., a multi-level authentication protocol) that requests secure authentication by the provider on the user interface 132 and/or on the EHR interface 150. The authentication protocol can be additionally or alternatively adapted to the computing device 600 coupled to the mobile provider interface 110 and worn by the provider, such that the provider is required to authenticate him/herself at the mobile provider interface 110. In some variations, the scribe can additionally or alternatively facilitate authentication of the provider (e.g., by providing queries to the provider that must be responded to in order to authenticate the provider's identity, by observing abnormalities generated at the mobile provider interface, etc.). In examples, the provider can perform any one or more of: verbally stating a passcode for authentication (e.g., in order to redundantly authenticate the provider by voice recognition authentication coupled with passcode authentication), inputting a passcode (e.g., alphanumeric passcode, series of gestures at an input device, “pass pattern” of swipes at a touch interface, etc.) at an input module, scanning an image of the provider (e.g., the provider's face, the provider's eye, the provider's fingers, etc) for authentication, scanning a tag (e.g., barcode, QR code) for authentication, and any other suitable action for authentication. Additionally or alternatively, the provider can be required to re-authenticate him/herself if no movement is detected within a specified time window at the provider workstation 130 and/or the computing device 600, if the computing device is transported outside of a geographic location (e.g., as detected by patient recognition, geolocation, physician voice recognition, bluetooth/wireless triggering, environmental image recognition, etc.), and/or according to any other suitable condition (e.g., according to “head detection” functionality of a head-mounted computing device). In still further variations, authentication can be facilitated by location-based sensing (e.g., by Bluetooth triangulation, Wi-Fi triangulation, etc.) can be implemented to facilitate authentication; as such, a detected proximity to a provider workstation 130, for a provider who has already authenticated his/her computing device, can automatically initiate authentication and/or data retrieval at the provider workstation 130. However, in other variations, the provider workstation 130 and/or the mobile provider interface 110 can entirely omit an authentication protocol and/or provide security in any other suitable manner.

While variations of the provider workstation 130 are described above, the provider workstation 130 can alternatively be any computing device that can be communicatively coupled with the system 100, is capable of displaying the user interface 132, and that allows the provider to review the communication, and/or edit and confirm content generated by the scribe. Such computing devices can include a desktop, a laptop, a tablet computers, and/or a mobile device (e.g., smartphone, wearable computing and communication device). In one variation, review can additionally or alternatively be performed by the provider at the mobile provider interface 110. However, review of the communication and/or manipulation of generated content can be performed in any other suitable manner.

### 1.4 System—Scribe Manager Module

The scribe manager module 140 functions to facilitate administration of a set of scribe tools to the scribe and manage a set of scribe-provider interactions, in order to resolve inefficiencies in the system 100. As shown in FIG. 1, the scribe manager module 140 can provide system management, and in one variation, can provide lightweight administrator web-based interface system management; however, system management can be performed by the scribe manager module 140 in a non-web-based manner, and/or in any other suitable manner. The scribe manager module 140 can be operated by a human system administrator, and/or can be operated by an automaton system administrator (e.g., virtual administrator implemented in software). In variations, the scribe manager module 140 can allow the system administrator to review and manage any one or more of: supply, demand, outages, routing, auditing, performance reviews, permission granting, permission removals, schedules and other administrative tasks common to the management of large distributed systems such as herein described. The system administrator can also audit ongoing communications between doctors and scribes using embodiment of the system 100 as well as archived communications and/or media. The scribe manager module 140 preferably facilitates implementation of at least a portion of the method 200 described in section 2 below; however, the scribe manager module 140 can additionally or alternatively be configured to facilitate implementation of any other suitable method for improving healthcare provider performance.

### 1.5 System—Additional Elements

In some variations, the system 100 can further include an electronic health record (EHR) interface 150 coupled to at least the scribe cockpit 120 and the provider workstation 130, which functions to provide information regarding health records of at least one patient of the provider. The EHR interface 150 can additionally or alternatively be coupled to the mobile provider interface 110, such that the provider has substantially constant access to the EHR interface 150, even when he or she is away from the provider workstation 1300. The EHR interface 150 is preferably coupled in a manner that allows simultaneous secure logins by the provider and the scribe; however, in other variations, the EHR interface 150 can be configured to allow logins in any other suitable manner (e.g., non-simultaneous multiple logins, separate EHR interfaces for the provider and the scribe, etc.). In one variation, the EHR interface 150 can be a remote log-in version of an EHR accessed by the provider, which in examples can be, implemented using the EPIC EHR system, the NEXTGEN EHR system, or any other suitable EHR system. As such, when a scribe enters data or content on behalf of the provider, related to the set of interactions between the provider and a patient, the scribe enters the data directly into the EHR interface 150 from his/her computer. Furthermore, when the doctor queries information (e.g. ‘“give me the White Blood Cell count”) at the provider workstation 130 or the mobile provider interface 110, the scribe may scout out this information by navigating the EHR interface 150

The EHR interface 150 is configured to enable connectivity to an electronic health record of the patient(s) of the provider in a secure manner according to federal regulations (e.g., HIPAA regulations). The electronic health record can include patient information pertaining to any one or more of: demographic information, medical history information, medication information, supplement information, allergy information, immunization records, laboratory test results, radiology images, non-radiology images, vital signs, personal statistics (e.g., age and weight), insurance information, billing information, visit information, and any other suitable patient information. As shown in FIG. 2, connecting to the EHR interface 150 is preferably achieved through direct APIs and/or HL7 standards, as shown in FIG. 2; however, in other variations, connecting to the EHR interface 150 can be achieved in any other suitable manner.

The system 100 can, however, including any other suitable elements for improving healthcare provider performance. Furthermore, as a person skilled in the field of optical user interface devices will recognize from the previous detailed description and from the figures and claims, modifications and changes can be made to the embodiments, variations, examples, and specific applications of the system 100 described above without departing from the scope of the system 100.

### 2. Method

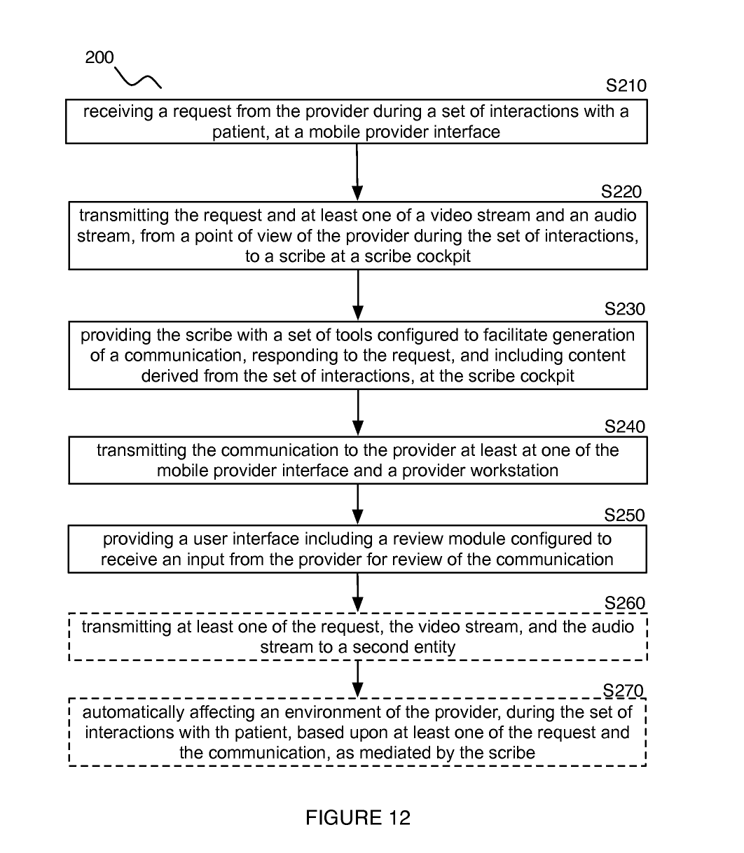

As shown in FIG. 12, an embodiment of a method 200 for augmenting performance of a provider includes: receiving a request from the provider, during a set of interactions with a patient, at a mobile provider interface S210; transmitting the request and at least one of a video stream and an audio stream, from a point of view of the provider during the set of interactions, to a scribe at a scribe cockpit S220; providing the scribe with a set of tools configured to facilitate generation of a communication, responding to the request of the provider and including content derived from the set of interactions, at the scribe cockpit S230; transmitting the communication to the provider at least at one of the mobile provider interface and a provider workstation S240; and providing a user interface including a review module configured to receive an input from the provider for review of the communication, thereby augmenting performance of the provider S250. In some embodiments, the method 200 can further include transmitting at least one of the request, the video stream, and the audio stream to a second entity S260 to further facilitate the provider; and automatically affecting an environment of the provider, during the set of interactions with the patient, based upon at least one of the request and the communication, as mediated by the scribe S270.

The method 200 functions to significantly decrease or eliminate an amount of time over which a provider must enter information into a database, thus increasing the time the provider has to spend with a given patient, and increasing the quality of provider-patient interactions. As such, the method 200 can free the provider from a set of mundane tasks, which can be instead performed by a human and/or an automaton (e.g., virtual) scribe. Furthermore, while the method 200 can facilitate a scribe in providing a response to a request from a provider, variations of the method 200 can additionally or alternatively include facilitating a scribe in pushing information (e.g., to a provider, to another entity, to another system) in an unprompted manner. Additionally, the method 200 can facilitate the scribe in documenting and providing non-EHR structured data to institutions associated with a patient and/or a provider (e.g. Kaiser Permanente desires patient/provider interaction patterns prior to performance of a pap smear, Blue Cross desires information regarding which drugs are discussed prior to an order for a Lipitor prescription, etc.). The method 200 is preferably implemented at least in part using an embodiment of the system 100 described above; however, in other embodiments, the method 200 can be implemented using any other suitable system 100 configured to augment healthcare provider performance.

Block S210 recites: receiving a request from the provider, during a set of interactions with a patient, at a mobile provider interface, and functions to enable the provider to transmit a query to a scribe in a secure manner. The request is preferably received in real time; however, in variations of Block S210, the request can alternatively be received in non-real time. The request is preferably derived from signals generated at an audio sensor. Additionally or alternatively, the request can be derived from signals generated at an optical sensor (e.g., image sensor). As such, the provider can provide the request in an auditory manner (e.g., by speaking the request) and/or the provider can provide the request in a visual manner (e.g., by writing the request, by making motions to provide the request, by sending an image to provide the request, etc.). In other variations, the request can additionally or alternatively be derived from signals generated at an input device (e.g., touchscreen, touch-sensitive pad, keypad, etc.). In variations of Block S210, the request can be any one or more of: a request for patient-specific information to be retrieved from an EHR, a request for information related to past interactions with the patient (e.g., test results for the patient), a request related to a therapy and/or medication regimen for the patient (e.g., a request to generate, authorize, and/or fill a prescription order of the patient), a request for a scribe to document an aspect of a provider-patient interaction (e.g., the provider can indicate a patient that a scribe should take notes for), a request for a scribe to not document an aspect of a provider-patient interaction (e.g., an input at a computing module can transmit a request to the scribe to not document a specified duration of an interaction), a request to communicate with another entity (e.g., a colleague, an entity associated with the patient, a caretaker of the patient, etc.), a request to facilitate translation for a patient speaking a language not understood by the provider, and any other suitable request.

In specific examples of Block S210, using a specific example of the system 100 described above, the request can be received from a provider who is wearing a computing device (e.g., Google Glass) capable of receiving audio and video signals from the point of view of the provider, and capable of transmitting audio and video streams at a mobile provider interface to a scribe cockpit. In one specific example, the provider can interface with the computing device either verbally (e.g., by speaking a predetermined phrase, or by swiping a touch-sensitive panel (e.g., by interfacing with a swipe and click interface and a display of a wearable computing device). In the specific example, the request can include a request to order a medication for the patient, wherein the ordering process is performed by a combination of verbal commands and interactions with a physical swipe/click interface (e.g., touch sensitive pad) of the computing device. In another specific example, the request can include a request to pull information from an EHR (e.g., the provider can request cell counts and other metrics related to the patient's health from an EHR), wherein the request is performed by a combination of verbal commands and interactions with a physical swipe/click interface (e.g., touch sensitive pad) of the computing device.

In variations of the specific examples of Block S210 implemented at a system capable of processing requests of the provider by voice recognition and/or natural language processing (NLP), Block S210 can further implement a vocabulary set usable by the provider at the computing device and related to potential orders, tests, medications, and requests to document an aspect of a provider-patient interaction, in order to facilitate the provider in making the request for the patient. In still further variations of the specific examples incorporating a system capable of speach recognition and/or NLP, Block S210 can incorporate utilization of a machine learning algorithm to recognize and adapt to patterns in the provider's verbalization of a request, in order to facilitate the provider in making subsequent requests or to improve the accuracy of processing of provided and received requests. The machine learning algorithm can be an algorithm trained by audio signal data of requests generated by the provider, and/or any additional provider(s). In the specific example, involving a request to place an order for a medication, the mobile provider interface and the computing device can further facilitate guidance of the provider in providing ordering a medication for the patient, wherein a portion of the request (e.g., requesting the name of a medication) triggers display of the next decision point in an ordering process (e.g., the dosage of the medication, the usage of the medication, etc.) until the request is complete. As such, receiving the request can include receiving a set of subrequests, wherein receiving each subrequest of the set of subrequest triggers display of a subsequent decision point, until provision of the request is complete. However, other variations of the specific example can entirely omit guidance of the provider in providing the request, or can include guidance of the provider in requesting any other suitable order (e.g., diagnostic, therapeutic) in any other suitable manner.

Block S220 recites: transmitting the request and at least one of a video stream and an audio stream, captured during at least a portion of the set of interactions, to a scribe at a scribe cockpit, and functions to provide the scribe with information from the provider's interactions with a patient, in order to enable a satisfactory response to the request to be provided by the scribe. The request, the video stream, and/or the audio stream are preferably transmitted continuously and substantially in real time; however, any one or more of the request, the video stream, and the audio stream can transmitted intermittently and/or in non-real time. Furthermore, the request is preferably temporally synchronized with at least one of the audio stream and the video stream. In a specific example, implemented at an embodiment of the system 100 described above, the request can be transmitted by way of a computing device (e.g., Google Glass) worn by the provider and capable of receiving audio and video signals from the point of view of the provider, and capable of transmitting audio and video streams at a mobile provider interface to the scribe cockpit.

In some variations, Block S220 can include providing an indication to the provider, at the mobile provider interface, that the request, the video stream, and/or the audio stream are being transmitted and/or have been transmitted to the scribe. For example, Block S220 can include providing a visual indication (e.g., a popup or flash on a display) and/or an audio indication (e.g., a ring notification) at a computing device worn by the provider, in order to confirm reception of the request at the scribe cockpit. The indication can be automatically triggered at the computing device when the provider enters into proximity of the patient (e.g., as implemented using patient recognition, geolocation, bluetooth/wireless triggering, environmental recognition, etc.). The indication can serve not only as a confirmation of transmittal/reception of the request at the scribe cockpit, but can also enable the provider to confirm the content of the request.

For example, in an application involving a request to place an order for a medication of the patient, the indication provided in Block S220 can provide confirmation that the medication request was transmitted for ordering without conflict, can provide confirmation of the presence of any allergy conflicts, can provide confirmation of the presence of any adverse interactions with other medications of the patient, can provide confirmation of the location where the medication will be filled, can provide confirmation of the patient's insurance information, can provide confirmation of all medications currently being taken by the patient, and/or can provide confirmation of any other suitable medication-related information of the patient being treated by the provider. In another specific example of an application wherein the provider requests communication with one or more colleagues, the indication can be rendered at a display of a computing device worn by the provider and include a picture, title, priority level, geolocation, and/or status (e.g., available, unavailable) of the colleague(s) communicating with the provider. In other variations of the specific examples, the indication can provide confirmation of ordered test results of the patient (e.g., an indication that a lab test or image is ready to view), and/or any other suitable order related to a therapy, medication, status (e.g., location of the patient at a healthcare facility), or diagnostic of the patient. In still other variations, involving request to document an aspect of a provider-patient interaction, the provider can further receive an indication in real-time of the documentation (e.g., the provider can see text creation performed by the scribe, in relation to the interaction, in real time at a display of the computing device). In still other variations, the indication can inform the provider of a queue of stacked and/or shrinking requests. For example, tags for requests can be rendered at the display and then translocated within the display to a peripheral region, in order, in order to indicate a queue of sent and/or pending requests. Additionally, tags for queued requests can be modulated (e.g., by adjusting a size of the tag, by adjusting a color of the tag), in order to provide an indication to the provider of an expected duration over which the request will be responded to. The indication is preferably a visual indication rendered as text and/or graphics at a display of a computing device worn by the provider; however, the indication can alternatively be presented to the provider and/or any other suitable entity, in any other suitable manner.

### 2.1 Method—Scribe Tools

Block S230 recites: providing the scribe with a set of tools configured to facilitate generation of a communication, responding to the request of the provider and including content derived from the set of interactions, at the scribe cockpit. Block S230 functions to enable the scribe to respond to the request of the provider and to equip the scribe with a set of tools to adequately respond to the request. The set of tools is preferably implemented at a scribe software module executing at the scribe cockpit, as described in relation to an embodiment of the system 100 described above; however, the set of tools can alternatively be implemented using any other suitable software/non-software module. The communication preferably includes one or more of: a response to the request (e.g., portions of EHR information for the patient requested by the provider, lab test results requested by the provider, etc.), a summary of the set of interactions between the provider and the patient, detailed information regarding aspects of the set of interactions between the provider and the patient, and any other suitable information configured to improve performance of the provider during interactions with the patient and/or any other subsequent interaction of the provider.

The set of tools preferably includes a template aid tool, which performs one or more of: importing standardized templates (e.g., for documenting provider-patient interactions), allowing the scribe(s) to input information into the templates, providing options (e.g., by drop-down menus, by auto-completing partially inputted information) to the scribe to aid information input, providing audio and/or video streams of provider-patient interactions relevant to template completion, providing audio and/or video manipulation tools (e.g., rewind, fast forward, pause, accelerated playback, decelerated playback tools) that are controlled by an input module (e.g., mouse, keyboard, touchpad, foot pedals, etc.) to facilitate information retrieval for template completion, providing template annotation tools (e.g., font editing tools, confidence indicators), providing any other post-patient interaction information (e.g., free form notes generated by the provider and/or another entity), and any other suitable template aid function. In particular, providing audio and/or video manipulation tools can facilitate multimedia capture and incorporation of multimedia (e.g., selected image/video clips, edited image/videos) into content generated or prepared by the scribe (e.g., as in multimedia-laden EHR notes). In variations of the set of tools including provision of audio and/or video streams to the scribe, the set of tools can also enable to provide real time and/or delayed feedback to the provider regarding aspects of the interactions with the patient (e.g., bedside manner comments) to improve performance.

The set of tools provided in Block S230 can additionally or alternatively include a self review tool that enables the scribe to access metrics related to his/her productivity (e.g., in relation to at least one other scribe, in relation to the scribe for an individual comparison) and enables the scribe to access a history of a communication (e.g., documentation of content provided by the scribe to the provider), such that the scribe can learn from the history of edits made to the communication during review by the provider in variations of Block S250. The set of tools can additionally or alternatively include an EHR navigation tool that enables the scribe to access an EHR of a patient, to manipulate aspects of an EHR for the patient (e.g., record, copy, paste EHR content), to prepare portions of an EHR for the patient for transmission to the provider at the computing device worn by the provider, and to communicate aspects of requested EHR information to the provider (e.g., by free-form messaging). In variations, the set of tools can additionally or alternatively include a schedule manipulation tool configured to aid the scribe in viewing and editing a patient schedule, In variations, the set of tools can additionally or alternatively include an order facilitation tool, whereby the scribe can hear and/or visualize orders generated by the provider in real time, and respond according to guidance provided by the order facilitation tool (e.g., by decision tree guidance, by checklists, etc.). In variations, the set of tools can include a billing calculation tool that the scribe can use to determine appropriate billing based upon factors of the provider-patient interaction (e.g., complexity of patient visit, services performed during the patient visit, tests performed during the patient visit, medications ordered for the patient, time spent interacting with the patient, patient insurance information, etc.). In variations including a billing calculation tool, the billing calculation tool can additionally or alternatively be used to provide feedback to the provider (e.g., at the computing device worn by the provider using the mobile provider interface) regarding additional tasks that must be performed in order to meet a specified billing amount. The set of tools can additionally or alternatively include a scribe management tool that enables a scribe manager module, such as the scribe manager module described in relation to the system 100 described in Section 1 above, to review and manage supply and demand of scribes to providers, system outages, and routing of requests between scribes and providers, to audit scribes, to perform analyzes of performance reviews for a scribe, and to initiate and terminate permissions, view/edit schedules, and to perform any other suitable scribe management action. The set of tools can, however, include any other suitable tool that facilitates interaction documentation by a scribe, and/or scribe management. Furthermore, in variations of the method 200 involving an automaton scribe, the set of tools in Block S230 can omit tools intended for a human scribe, and/or include any other suitable tools for an automaton scribe.

### 2.2 Method—Additional Steps

Block S240 recites: transmitting the communication to the provider at least at one of the mobile provider interface and a provider workstation, and functions to provide a response configured to satisfy the request of the provider. With regard to requests provided by the provider to the scribe during the set of interactions with the patient, the communication is preferably transmitted directly to the provider in real time (e.g., by way of the computing device worn by the provider) at the mobile provider interface, such that the provider can efficiently interact with the patient. With regard to summaries and/or detailed descriptions of aspects of the set of interactions between the provider and the patient, the communication is preferably transmitted to the provider at the provider workstation, and can additionally or alternatively be transmitted to the provider at a computing device worn by the provider, by way of the mobile provider interface. The communication is preferably transmitted and rendered in a visual format, including text and/or images configured to be viewed at a display accessible to the provider. Additionally or alternatively, the communication can be transmitted in an audio format and/or any other suitable format that conveys information to the provider. The communication can be transmitted during the set of interactions between the provider and the patient, and/or can be transmitted after the set of interactions between the provider and the patient have commenced.

In an example wherein the communication transmitted in Block S240 includes a summary of the set of interactions, the communication includes the name of the patient, a picture of the patient, the medical record number of the patient, the current medications/therapies of the patient, newly prescribed medications/therapies of the patient, placed orders (e.g., tests), a total duration of the set of interactions, and an encounter reimbursement score (e.g., a metric that indicates whether certain checklist interactions took place for billing or feedback purposes), and is rendered visually at a display of a computing device worn by the provider, after the set of interactions have commenced. In another example wherein the communication responds to a request for patient information from an EHR, the requested information can be rendered visually and/or played audibly at a computing device worn by the provider. In another example wherein the communication responds to a request for test results, the requested information can be rendered visually and/or played audibly at a computing device worn by the provider. In another example wherein the communication responds to a request for medical images taken of the patient, the images can be rendered visually at a computing device worn by the provider. In another example wherein the communication responds to a request for translation, the translated speech (e.g., as translated by a human or a virtual entity) of the patient can be rendered as text at a display of the provider in real time, and/or can be provided in an audio format using a speaker configured to transmit audio to the provider. In another example wherein the communication comprises a detailed description of the set of interactions between the provider and the patient, a transcript of the set of interactions can be provided at the provider workstation in a text format and/or an audio format. In any of the above examples, the communication(s) can be annotated with notes provided by the scribe (e.g., annotations regarding confidence in the accuracy of information documented by the scribe, annotations to highlight pertinent portions of the set of interactions, etc.). However, the communication can be transmitted in any other suitable manner.

Block S250 recites: providing a user interface including a review module configured to receive an input from the provider for review of the communication, thereby augmenting performance of the provider. Block S250 functions to enable verification of content generated by the scribe, in response to requests of the provider and/or in response to the set of interactions between the provider and the patient. The review module can be implemented using embodiments of the mobile provider interface and/or the provider workstation as described in Section 1 above, such that the provider can review content generated by the scribe(s) during interactions with the patient and/or after interactions with the patient. As such, the user interface can incorporate a display configured to present information to the provider, and an input module (e.g., keyboard, mouse, touchpad, touchscreen, voice command module, etc.) configured to receive inputs from the provider for review of content. Preferably, the review module is capable of enabling the provider to review the accuracy of content generated by the scribe, communicated to the provider, and recorded in records of the patient, and is capable of receiving inputs from the provider configured to amend and/or highlight aspects of content generated by the scribe. The review can thus be used to increase the quality of content generated for a patient, to provide feedback to the scribe generating the content (e.g., in order to improve the performance of the scribe in generating future content), and/or to provide feedback to the provider, such that the performance of the provider can be augmented.

In some variations, Block S250 can include storing and providing a complete audio and/or video stream of the set of interactions with the patient to the provider for subsequent review. Furthermore, Block S250 can include storing and providing a history of complete audio and/or video streams of past interactions with the patients, in order to facilitate more complex analyses of the provider-patient interactions to be performed. In these variations, complete audio and video streams are preferably searchable and manipulatable, in order to facilitate the review of the provider; however, the audio and/or video streams can be configured in any other suitable alternative manner. In an example, Block S250 includes allowing the provider to rewind, fast forward, pause, play, accelerate, decelerate, and export audio/video streams. In an example, Block S250 includes implementing speech recognition software (e.g., a speech recognition API) to enable searching of at least one of the audio stream and the video stream provided to the provider. Additionally or alternatively, transcripts of the set of interactions can be provided to the provider in Block S250.

In an example, Block S250 can include automatically or, upon command by the provider, drawing attention to portions of the communication (e.g., portions of increased concern due to uncertainty or clinical significance) for review by the provider. In examples, drawing attention to portions of the communication includes highlighting around text, adjusting font color of text, adjusting audio parameters (e.g., volume, clarity) of portions of interest of the communication, and adjusting visual parameters (e.g., visibility, clarity) of portions of interest of the communication. Drawing attention to portions of the communication can include providing context about portions of interest (e.g., by highlighting contextual text portions, by adjusting contextual visual parameters, by adjusting contextual audio parameters, etc.). In the example, Block S250 can then include allowing the provider to amend and/or confirm content generated by the scribe (e.g., by providing a confirmation input at an input module coupled to the user interface). Upon confirming content, the provider can then send feedback to the scribe and/or another entity (e.g., regarding quality of content generated by the scribe) in a qualitative (e.g., free form text/verbal feedback) and/or quantitative (e.g., using a scale of values) manner. The user interface in the example is in synchronization with an EHR according to HL7 standards; however, in variations of the example, the user interface can alternatively be configured in any other suitable manner.

As shown in FIG. 12, the method 200 can further include Block S260, which recites: transmitting at least one of the request, the video stream, and the audio stream to a second entity. Block S260 functions to further facilitate augmentation of the provider's performance, in enabling at least one other entity to observe the set of interactions and/or respond to the request(s) of the provider. Block S260 can include transmitting at least one of the request, the video stream, and the audio stream to a consultant, which enables the consultant to observe an aspect of a provider-patient interaction from the point of view of the provider. Upon transmission, Block S260 can then include receiving feedback from the consultant regarding a condition of the patient, as observed in the transmission to the consultant (e.g., the consultant can be a dermatologist observing and responding to a skin condition of the patient). The feedback can be received at an embodiment of the provider workstation and/or the mobile provider interface, as described above. Block S260 can additionally or alternatively include transmitting at least one of the request, the video stream, and the audio stream to a trainee (e.g., of the provider), which enables the trainee to observe an aspect of a provider-patient interaction (e.g., a surgical procedure) from the point of view of the provider. Block S260 can additionally or alternatively include transmitting at least one of the request, the video stream, and the audio stream to a caretaker of the patient (e.g., a family member, a therapist), which enables the caretaker to observe an aspect of a provider-patient interaction from the point of view of the provider. However, other variations of Block S260 can include transmission of at least one of the request, the video stream, and the audio stream to any other suitable entity.

Also shown in FIG. 12, the method 200 can further include Block S270, which recites: automatically affecting an environment of the provider, during the set of interactions with the patient, based upon at least one of the request and the communication, as mediated by the scribe. Block S270 functions to transform or manipulate aspects of the environment of the provider, while the provider is interacting with the patient, in order to enhance the performance of the provider. In variations, Block S270 can include providing an interface between the scribe cockpit, the mobile provider interface, the provider workstation, and at least one module present during the provider-patient interactions, wherein the module(s) is/are configured to receive an input from at least one of the provider and the scribe, and are configured to generate an output in response to the input(s). In one example, the module can include a printer (e.g., 2D printer, 3D printer) that can be used to automatically print visual data (e.g., test results, medical images, medication information, therapy information, etc.) upon request by the scribe and/or the provider. In another example, the module can include a screen configured to present a rendering of visual data upon request by the scribe and/or the provider. In another example, the module can include a speaker configured to output audio relevant to the provider patient interaction(s) upon request by the scribe and/or the provider. In another example, the module can include environmental controls (e.g., of lighting, of temperature, of humidity, etc.) configured to affect an environment of the provider/patient during the interaction. However, Block S270 can additionally or alternatively include affecting an environment of the provider using any other suitable modules, in any other suitable manner.

The method 200 can, however, include any other suitable steps configured to augment provider performance. As such, the method 200 can include any one or more of: providing real time vital statistics (e.g., blood pressure, heart rate, etc.) of the patient during the set of interactions as obtained from at least one biomonitoring device coupled to the patient; guiding the provider in his/her clinical setting (e.g., by accessing healthcare staff levels, by interfacing with geolocating devices configured to detect patient proximity, by integrating a healthcare setting layout, by accessing information about patient conditions, by accessing test results of the patient, etc.); facilitating the provider in receiving and documenting patient consent (e.g., by recording audio and/or video of the consent) from the patient and/or a caretaker of the patient (e.g., for hospitalization, for a surgical procedure, for a therapy, for a medication, etc.); implementing face and/or expression detection at the mobile provider interface, such that the provider is able to identify entities within his/her field of vision, and/or respond to emotions of patients conveyed in facial expressions, in order to provide better treatment; facilitating the provider in measuring features of a patient encountered during diagnosis or treatment (e.g., incision dimensions, tissue morphological dimensions, etc.); implementing visual detection algorithms using data generated at an image sensor (e.g., in order to scan identification cards of the patient to facilitate access and retrieval of patient information); enabling object recognition, at the mobile provider interface, of objects in proximity to the provider (e.g., tools used for surgical procedures), in order to prevent malpractice (e.g., by misuse of tools) and/or in order to retrieve instructions for use of objects in proximity to the provider; automatically analyzing provider-patient interactions (e.g., including evaluation of patient outcomes, receiving of patient satisfaction information, etc.) to provide feedback to the provider to improve his/her performance; automatically responding to technical issues of the system (e.g., anticipating power losses, storing information locally during a power or transmission loss, optimizing energy use of a computing device worn by the provider by modulating wireless transmission elements); and any other suitable step that facilitates augmentation of provider performance.

Variations of the system too and method 200 include any combination or permutation of the described components and processes. Furthermore, various processes of the preferred method can be embodied and/or implemented at least in part as a machine configured to receive a computer-readable medium storing computer-readable instructions. The instructions are preferably executed by computer-executable components preferably integrated with a system and one or more portions of the control module 155 and/or a processor. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processor, but any suitable dedicated hardware device or hardware/firmware combination device can additionally or alternatively execute the instructions.

The FIGURES illustrate the architecture, functionality and operation of possible implementations of systems, methods and computer program products according to preferred embodiments, example configurations, and variations thereof. In this regard, each block in the flowchart or block diagrams may represent a module, segment, step, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

1. A computing system executing machine-readable instructions for augmenting performance of a provider, comprising:
a mobile provider interface including a coupling module coupled to a display, an optical sensor, and a microphone worn by the provider, wherein the mobile provider interface communicates information to the provider, during a set of interactions with a patient, by the display and the coupling module, and enables the provider to generate a request to be transmitted through the coupling module;
a scribe cockpit interface configured to transmit the request from the provider and a video stream and an audio stream collected from a point of view of the provider by way of the optical sensor and the microphone, from the mobile provider interface to a scribe, and to transmit a communication between the scribe and the provider, wherein the communication responds to the request;
a provider workstation interface including an input module configured to receive an input from the provider and to facilitate review of the communication by the provider at a provider workstation, wherein the mobile provider interface is coupled to the scribe cockpit interface by way of a cloud service configured to transmit the video stream and the audio stream to the scribe, and wherein the provider workstation interface is in communication with the cloud service;
a scribe manager module configured to electronically administrate a set of scribe tools to the scribe at the scribe cockpit interface and manage a set of scribe-provider interactions, thereby supporting the communication; and
an EHR interface coupled to at least the mobile provider interface and the scribe cockpit interface, and configured to enable patient information transfer to the provider and to the scribe to facilitate generation of the communication, thereby augmenting performance of the provider.

2. The system of claim 1, wherein the coupling module of the mobile provider interface is a wireless coupling module configured to receive the video stream and the audio stream continuously and substantially in real time from a communication link of a head-mounted computing device worn by the provider, wherein the computing device comprises an optical sensor configured to generate the video stream, an audio sensor configured to generate the audio stream, and the display.

3. (canceled)

4. The system of claim 1, wherein the scribe cockpit interface includes a first module configured to receive inputs generated by the scribe in response to the request, and a second module configured to provide the set of scribe tools to the scribe, thereby facilitating generation of the communication.

5. The system of claim 4, wherein the set of scribe tools includes a self review tool configured to provide a productivity metric to the scribe based upon a history of edits made to the communication by the provider, and a billing calculation tool that enables the scribe to determine appropriate billing of the patient, based upon observation of the set of interactions from the video stream and the audio stream.

6. The system of claim 5, wherein the provider workstation interface includes a triangulation sensing device is configured to communicate with a location sensor of the head-mounted computing device, and configured to automatically authenticate the provider, upon detection of the location sensor in proximity to the provider workstation.

7. The system of claim 5, wherein at least one of the mobile provider interface and the scribe cockpit interface includes a processing element configured to implement natural language processing algorithms configured to automatically incorporate speech information derived from the set of interactions into a health record of the patient.

8. A method for augmenting performance of a provider, comprising:
receiving a request, an audio stream, and a video stream, from the provider at a wearable computing device, during a set of interactions with a patient, at a computing system comprising a mobile provider interface coupled to the wearable computing device;
transmitting, from the wearable computing device, the request, the video stream, and the audio stream, from a point of view of the provider during the set of interactions, to a scribe at a scribe cockpit comprising a display in communication with a scribe cockpit interface;
providing the scribe with a set of tools, at the scribe cockpit interface and visualized at the display, configured to facilitate generation of a communication, responding to the request of the provider and including content derived from the video stream and the audio stream capturing the set of interactions, at the scribe cockpit;
transmitting the communication, from the scribe cockpit, to the provider during the set of interactions with the patient at least at one of the wearable computing device and a provider workstation, wherein the mobile provider interface is coupled to the scribe cockpit interface by way of service configured to transmit the video stream and the audio stream to the scribe, and wherein the provider workstation interface is in communication with the service; and
providing a user interface at the provider workstation including a review module comprising an input device configured to receive an input from the provider for review of the communication, thereby augmenting performance of the provider.

9. The method of claim 8, wherein receiving the request from the provider includes receiving audio signals generated at an audio sensor of a head-mounted computing device worn by the provider during the set of interactions.

10. The method of claim 9, wherein receiving the request includes receiving the request of an order of at least one of a prescription and patient health information for the patient, and further includes receiving and processing signals indicative of the order and generated at a swipe-and-click interface of the head-mounted computing device.

11. The method of claim 9, wherein receiving the request can includes receiving a set of subrequests from the provider, wherein receiving each subrequest of the set of subrequests triggers display, at the head-mounted computing device worn by the provider, of a subsequent decision point configured to guide provision of the request, at the head-mounted computing device, until provision of the request is complete.

12. (canceled)

13. The method of claim 8, wherein providing the scribe with a set of tools includes providing a template aid tool configured to import a patient template and automatically facilitate completion of the patient template.

14. The method of claim 13, wherein providing the scribe with a set of tools further includes:
enabling the scribe to observe a review history of a past communication, after review by the provider, at a self review tool configured to provide a productivity metric to the scribe based upon a history of edits made to the past communication by the provider;
providing an EHR navigation tool that enables the scribe to manipulate at least one aspect of an EHR for the patient and include a manipulated aspect of the EHR with the communication;
providing a billing calculation tool that aids the scribe in determining billing of the patient, upon observation of the set of interactions captured in the video stream and the audio stream; and
transmitting information derived from interactions of the scribe with the set of tools to the provider, by way of the service, thereby facilitating generation of the productivity metric provided at the self review tool.

15. The method of claim 8, wherein transmitting the communication to the provider includes rendering a summary of the set of interactions, generated at least in part by the scribe, at a head-mounted display of a head-mounted computing device worn by the provider, wherein rendering of the summary at the head-mounted display prevents the patient from viewing the summary.

16. The method of claim 8, wherein transmitting the communication to the provider includes rendering a portion of an EHR record of the patient, manipulated by the scribe, at a display of a head-mounted computing device worn by the provider.

17. The method of claim 8, wherein providing the user interface including the review module includes allowing the provider to transmit feedback to the scribe at the scribe cockpit, by way of the review module.

18. A method for augmenting performance of a provider, comprising:
receiving a request and a video stream from the provider, during a set of interactions with a patient, at a computing system comprising a mobile provider interface;
transmitting the request and the video stream, from a point of view of the provider generated at a computing device worn by the provider during the set of interactions, to a scribe at a scribe cockpit comprising a display in communication with a scribe cockpit interface;
providing the scribe with a template completion tool configured to at least partially complete a template upon reception of an input by the scribe, a video manipulation tool configured to allow the scribe to manipulate the video stream, and an EHR navigation tool that enables the scribe to manipulate and select at least one aspect of an EHR for the patient, wherein the template completion tool, the video manipulation tool, and the EHR navigation tool are provided by way of the scribe cockpit interface and visualized at the display;
allowing the scribe to generate a communication responding to the request and derived from at least one of the template completion tool, the video manipulation tool, and the EHR navigation tool, at the scribe cockpit;
transmitting the communication to the provider at least at one of a wearable computing device configured to transmit visual information to the provider and coupled to the mobile provider interface and a provider workstation comprising an input device, wherein the mobile provider interface is coupled to the scribe cockpit interface by way of a cloud service configured to transmit the video stream to the scribe, and wherein the provider workstation interface is in communication with the cloud service; and
providing a user interface including a review module at the provider workstation, configured to receive an input from the provider, at the input device, for review of the communication, thereby augmenting performance of the provider.

19. The method of claim 18, wherein receiving the request from the provider includes 1) receiving audio signals generated at an audio sensor of a head-mounted computing device worn by the provider during the set of interactions and 2) receiving signals generated at a swipe-and-click interface of the head-mounted computing device.

20. The method of claim 18, wherein transmitting the communication includes:
rendering a summary of the set of interactions, generated at least in part by the scribe, at a display of the computing device worn by the provider,
rendering a portion of an EHR record of the patient, manipulated by the scribe, at the display of the computing device worn by the provider, and
rendering a transcription derived from the set of interactions, and generated automatically by way of language processing module configured to interface with the mobile provider interface, at the provider workstation.

21. The method of claim 18, further including automatically facilitating local storage of at least one of the request, the video stream, and the communication in response to at least one of a power loss and a transmission issue.

22. The method of claim 8, further including receiving a supplementary biometric dataset characterizing biometric data of the provider during the set of interactions with the patient, generating an analysis of the set of interactions based upon the supplementary biometric dataset, the video stream, and the audio stream, and providing feedback to the provider at the wearable computing device, based upon the analysis, thereby facilitating the provider in improving performance.

23. The method of claim 22, further including detecting, at the computing system, a facial expression of the patient captured in the video stream during the set of interactions, generating an analysis of the facial expression, and providing feedback regarding an emotion of the patient to the provider at the wearable computing device, during the set of interactions, based upon the analysis of the facial expression.
